(19) United States
(12) Patent Application Publication
(10) Pub. No.: US 2011/0117935 A1
(43) Pub. Date: May 19, 2011

(54) METHOD AND APPARATUS FOR PERFORMING AND PROVIDING DOMAIN SERVICE

(75) Inventors: Hyung-rae CHO, Seoul (KR); Hyun-Joo OH, Seoul (KR); Sun-ae KIM, Seoul (KR); Ji-young KWAHK, Seongnam-si (KR)

(73) Assignee: Samsung Electronics Co., Ltd., Suwon-si (KR)

(21) Appl. No.: 12/946,519

(22) Filed: Nov. 15, 2010

(30) Foreign Application Priority Data
Nov. 13, 2009 (KR) 10-2009-0109446
Feb. 12, 2010 (KR) 10-2010-0013647
Nov. 11, 2010 (KR) 10-2010-0112126

(51) Int. Cl. H04W 4/02

(52) U.S. Cl. 455/456.3

(57) ABSTRACT

A method of performing the domain service including: receiving a request of user metadata from a domain service providing apparatus managing a position-based domain; sending user metadata to the domain service providing apparatus in response to the request; and receiving service information related to the domain from the domain service providing apparatus based on the user metadata.

### PRIORITY

This application claims priority under 35 U.S.C. §119(a) to Korean Patent Application No. 10-2009-0109446, filed on Nov. 13, 2009, Korean Patent Application No. 10-2010-0013647, filed on Feb. 12, 2010, and Korean Patent Application No. 10-2010-0112126, filed on Nov. 11, 2010, in the Korean Intellectual Property Office, the disclosures of which are incorporated in their entirety herein by reference.

### BACKGROUND OF THE INVENTION

1. Field of the Invention

The present invention generally relates to a method and apparatus for performing and providing a domain service, and more specifically, to a method and apparatus for performing and providing a domain service based on user metadata in a specific domain.

2. Description of the Related Art

Recently, interest in the introduction of a service using a femtocell has been increasing in mobile telecommunication companies. Femtocells are small cellular Base Stations (BSs) which connect to a service provider's network via broadband (such as cable or DSL). Among other things, femtocells allow a provider to extend service where it would be unavailable or limited (indoors, underground, etc.). Europe, the United States, Japan, and South Korea are considering introducing femtocells to mobile telecommunication services. Femtocells have various advantages such as improvement of indoor coverage, improvement of telephone conversation quality, reduction of operating costs, and the like. In addition, research has been actively conducted into femtocells, which are considered to have great growth potential.

### SUMMARY OF THE INVENTION

The present invention provides a method and apparatus for performing and providing a domain service related to a domain (e.g., a physical area covered by a femtocell BS) on the basis of user metadata.

According to an aspect of the present invention, there is provided a method of performing a domain service, the method including receiving a request for user metadata from a domain service providing apparatus managing a position-based domain; sending the user metadata to the domain service providing apparatus in response to the request; and receiving service information related to the domain from the domain service providing apparatus on the basis of the user metadata.

The service information is task information about a task to be performed in an apparatus for performing the domain service, the method further including setting the task on the basis of the received task information.

According to another aspect of the present invention, there is provided a method of providing a domain service, the method including when an apparatus entering a position-based domain is recognized, requesting the apparatus for user metadata; receiving the user metadata from the apparatus; extracting service information related to the domain on the basis of the user metadata; and sending the service information to the apparatus entering the domain.

According to another aspect of the present invention, there is provided a domain service performing apparatus including a receiving unit receiving a request for user metadata from a domain service providing apparatus for managing a position-based domain; a controller for determining the user metadata to be sent to the domain service providing apparatus in response to the request; and a transmitting unit for transmitting the determined user metadata, wherein the receiving unit receives service information related to the domain on the basis of the user metadata from the domain service providing apparatus.

According to another aspect of the present invention, there is provided a domain service providing apparatus including when an apparatus entering a position-based domain is recognized, a transmitting unit for requesting the apparatus for user metadata; a receiving unit for receiving user metadata from the apparatus; and a controller for extracting service information related to the domain on the basis of the user metadata and sending the service information to the apparatus entering the domain through the transmitting unit.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a method of performing and providing a domain service, according to an embodiment of the present invention;

FIG. 2 illustrates an example of user metadata, according to an embodiment of the present invention;

FIG. 3 illustrates an example of a method of providing domain service information when a domain area is a store, according to an embodiment of the present invention;

FIG. 4 illustrates an example of a method of providing domain service information when a domain area is a company, according to an embodiment of the present invention;

FIG. 5 illustrates an example of a method of providing domain service information when a domain area is a home, according to an embodiment of the present invention;

FIG. 6 is a block diagram illustrating a domain service performing apparatus and a domain service providing apparatus, according to an embodiment of the present invention;

FIG. 7 is a flowchart illustrating a method of performing and providing a domain service, according to another embodiment of the present invention; and

FIG. 8 illustrates a range of a domain, according to an embodiment of the present invention.

### DETAILED DESCRIPTION OF THE EMBODIMENTS OF THE PRESENT INVENTION

The present invention will now be described more fully with reference to the accompanying drawings, in which embodiments of the invention are shown.

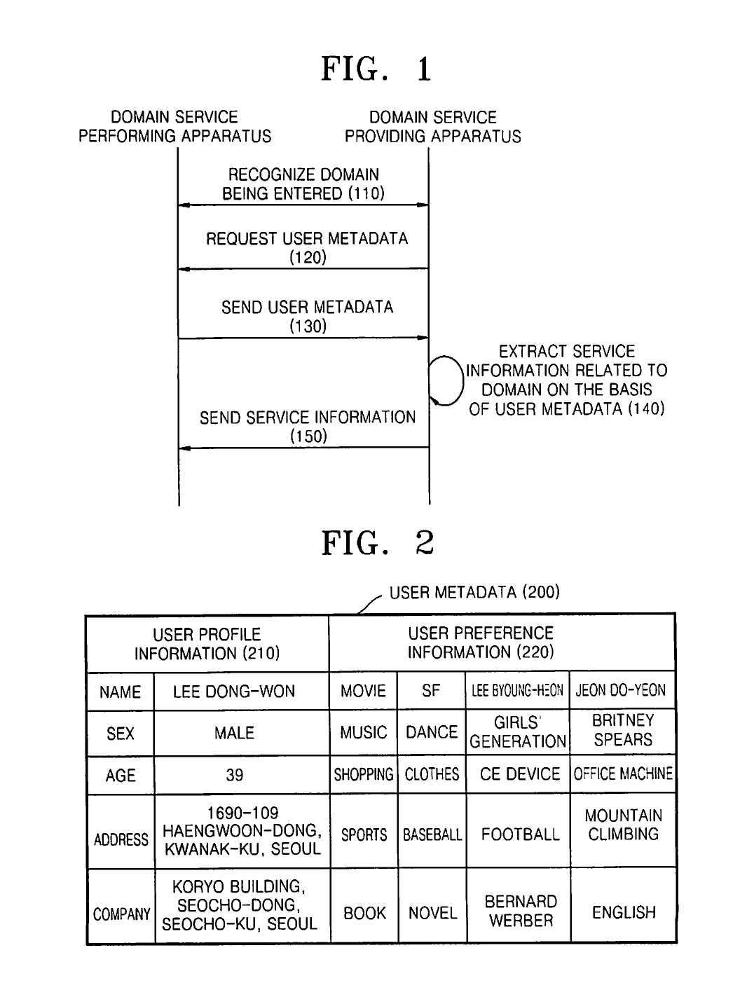

FIG. 1 illustrates a method of performing and providing a domain service, according to an embodiment of the present invention.

Referring to FIG. 1, a domain service performing apparatus (e.g., a mobile device) or a domain service providing apparatus (e.g., a femtocell BS) checks whether the domain service performing apparatus has entered a domain. That is, the domain service performing apparatus or the domain service providing apparatus checks that a domain change event is generated. The domain service providing apparatus is an apparatus for providing a service related to a domain, that is, a domain management apparatus or a domain management server. In the current embodiment, the domain may be a position-based domain, and may be a real area where the domain service providing apparatus may provide a service. The domain may also be a service area unit where a server or a BS is in charge. That is, the domain may be an area managed by the domain service providing apparatus in a predetermined network. For example, the domain may be an area covered by a femtocell. Femtocell is a technology that may freely use wired-wireless communication through a mobile phone by connecting a modem-type femtocell to a wired-IP network of each home. A position of a user, presence information, individual information, and the like may be obtained through the femtocell. Other technologies such as Wi-Fi or Wi-MAX may be used instead of the femtocell. However, the present invention is not limited to the above-described example regarding a network, and any network covering a predetermined area may be used.

The domain service performing apparatus may check whether the domain service performing apparatus has entered a domain, by receiving a broadcast message that is periodically transmitted from the domain service providing apparatus. Then, the domain service providing apparatus may recognize the domain service performing apparatus by sending a message, representing that the domain service performing apparatus entered a domain covered by the domain service providing apparatus from the domain service performing apparatus. Alternatively, after the domain service performing apparatus receives the broadcast message of the domain service providing apparatus, the domain service performing apparatus may not send a message to the domain service providing apparatus.

Alternatively, regardless of the broadcast message of the domain service providing apparatus, the domain service performing apparatus broadcasts a predetermined signal, so that only the domain service providing apparatus may check whether the domain service performing apparatus has entered the domain.

In step 120, the domain service providing apparatus requests that the domain service performing apparatus send the providing apparatus user metadata. If the domain service performing apparatus does not send a message to the domain service providing apparatus, step 120 may be omitted.

In step 130, the domain service performing apparatus sends user metadata to the domain service providing apparatus in response to the request of the domain service providing apparatus. User metadata may include user profile information which contains the user's history and user preference information (e.g., content preferred by the user). The user profile information may include, for example, the user's name, sex, age, address, hobbies, the name of the company where the user works, and the like. User preference information may include content preferred by the user such as movies, music, shopping items, and the like. However, the present invention is not limited to the above content of user profile information, or user preference information. The user himself may set the content. In the current embodiment, the user's metadata may be stored in the domain service performing apparatus, which is a personal apparatus, and managed to prevent any intrusion of privacy from occurring. However, when the privacy problems are solved, the user metadata may be stored in the domain service providing apparatus and managed.

FIG. 2 illustrates an example of user metadata 200, according to an embodiment of the present invention.

Referring to FIG. 2, the user metadata 200 includes user profile information 210 and user preference information 220. The user profile information 210 includes a user's name, sex, age, address, and an address of the company where the user works. User preference information 200 includes content such as movies, music, shopping, sports, and books preferred by the user. Specifically, user preference information 200 includes preferred movies genres and actors/actresses, music genres and singers, shopping items, sports, and book genres and writers. Detailed content of the user preference information 200 may also be ranked or not related to rank.

In the current embodiment, the domain service performing apparatus may send different user metadata to the domain service providing apparatus depending on a characteristic or type of the domain service providing apparatus without sending standardized user metadata to the domain service providing apparatus. For example, the domain service providing apparatus may receive user metadata such as credit card information when the domain service performing apparatus enters a domain such as a store, user metadata related to movie tickets reservation records or movie genres or actors/actresses preferred by the user that may be used in advertisements when the domain service performing apparatus enters a domain such as a theater, user metadata such as IDentification (ID) information related to access or vehicle information that may be used in an automation service such as a driver note, which is documents related to the management to cars, when the domain service performing apparatus enters a domain such as an apartment, and user metadata such as a student ID or a task file when the domain service performing apparatus enters a domain such as a school. In this case, the domain service providing apparatus may provide a different service to the domain service performing apparatus.

In step 140, the domain service providing apparatus extracts service information related to a domain based on the received user metadata. In the current embodiment, a domain service includes all services related to a domain that may be provided from the domain service providing apparatus to the domain service performing apparatus within a domain area. In the current embodiment, the service information may be information that may be provided to the domain performing apparatus by using user metadata. That is, user profile information or user preference information. Service information includes task information about a task to be performed in the domain service performing apparatus. That is, the domain service providing apparatus extracts task information about a task that may be performed in the domain service performing apparatus according to the user profile information or user preference information, which is a part of the user metadata.

In step 150, the domain service providing apparatus sends the extracted service information to the domain service performing apparatus. The domain service performing apparatus performs a service according to the service information when the domain service performing apparatus receives the service information from the domain service providing apparatus. If the received service information is task information, a task is automatically set according to the task information.

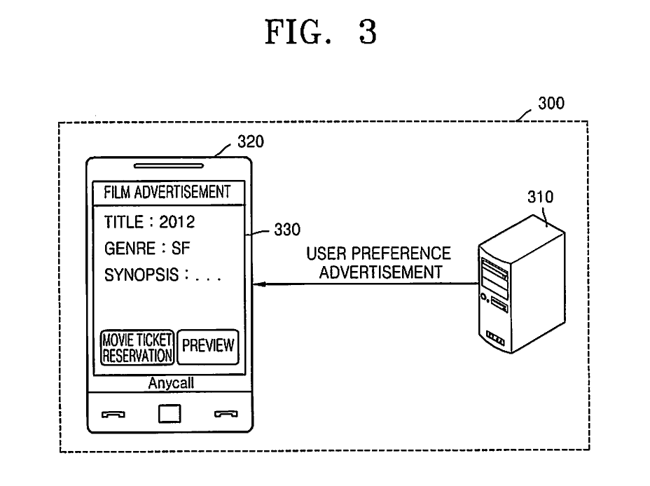

FIGS. 3 through 5 illustrate examples of a method of providing domain service information in a predetermined domain.

FIG. 3 illustrates an example with regard to a method of providing domain service information when the domain area is a store, according to an embodiment of the present invention.

Referring to FIG. 3, a domain service performing apparatus is a mobile device 320, and when a domain area 300 managed by a domain service providing apparatus 310 is a store, the domain service providing apparatus 310 extracts service information related to the store based on user metadata and sends the extracted service information to mobile device 320. When the domain area 300 is a theater, the domain service providing apparatus 310 extracts a film advertisement to be provided on the basis of preferred movie information from among user preference information included in the user metadata. Referring to FIG. 2, in the user preferences movie information, since a genre is Science Fiction (SF), the domain service providing apparatus 310 extracts movie information related to the SF genre. The domain service providing apparatus 310 then sends the extracted film advertisement to the mobile device 320. The mobile device 320 receives the extracted film advertisement and displays the received film advertisement 330. When the mobile device 320 receives a request for metadata from the theater, only movie-related user metadata is extracted and is then sent to the domain service providing apparatus 310, or movie-related user metadata, which is separately stored, may be sent to the domain service providing apparatus 310. When the domain area 300 is related to music, service information is extracted according to a genre preferred by the user by preferred music information in the user preference information, and is then sent to the mobile device 320. When domain area 300 is related to shopping, a shopping advertisement is extracted from user preference information about a shopping item that is preferred by a user and information about a product that is preferred by users having a user profile similar to the user profile, and is then sent to mobile device 320.

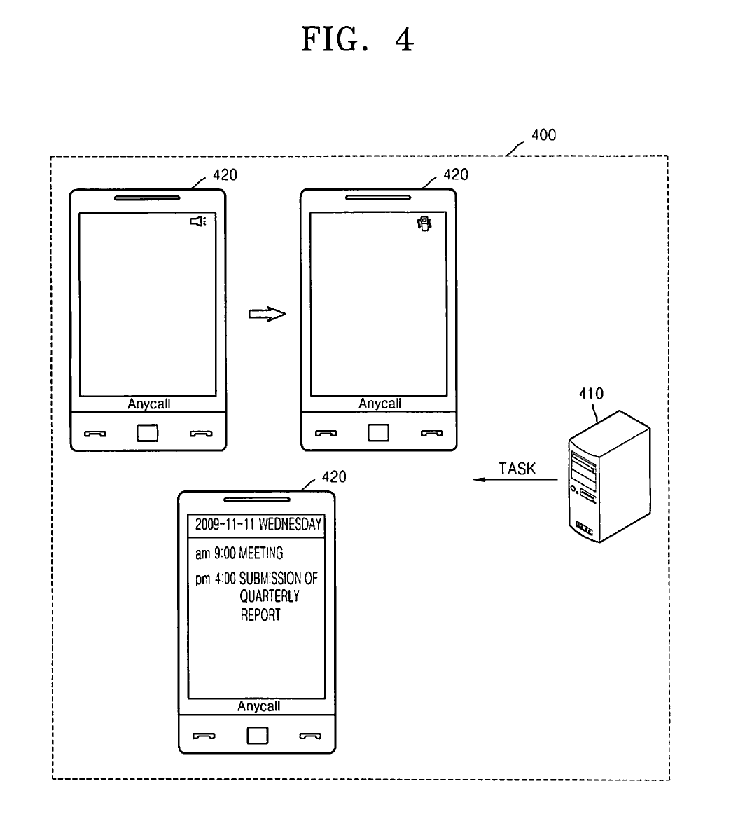

FIG. 4 illustrates an example of a method of providing domain service information when a domain area is a company, according to an embodiment of the present invention.

Referring to FIG. 4, a domain service performing apparatus is a mobile device 420, and when a domain area 400 managed by domain service providing apparatus 410 is a company, the domain service providing apparatus 410 extracts task information included in service information related to the company based on user metadata and sends the extracted task information to mobile device 420. The domain service providing apparatus 410 extracts task information related to the company on the basis of company information from among user profile information included in the user metadata and sends the extracted task information to the mobile device 420. The task information may be information regarding automatic conversion of a mode of the mobile device 420 to vibration mode or a silent mode and filtering and displaying emails related to a work schedule or a work project. Mobile device 420 may be automatically converted into vibration mode according to the received task information or may display information related to schedule management.

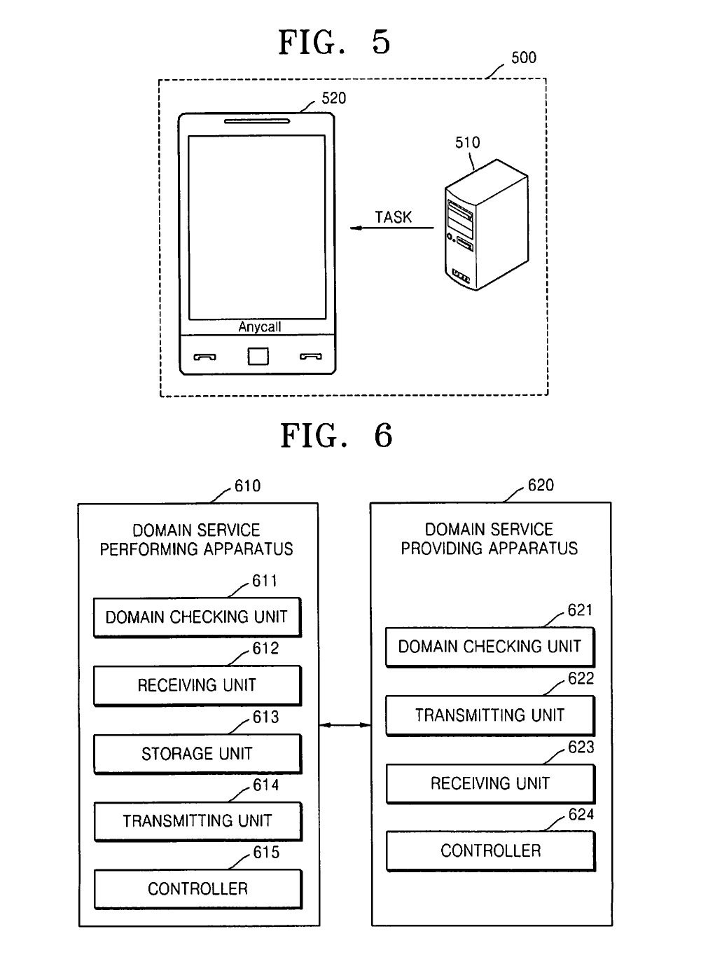

FIG. 5 illustrates an example of a method of providing domain service information when a domain area is a home, according to an embodiment of the present invention.

Referring to FIG. 5, a domain service performing apparatus is a mobile device 520, and when a domain area 500 managed by a domain service providing apparatus 510 is a home, the domain service providing apparatus 510 extracts task information included in service information related to a home on the basis of user metadata, and sends the extracted task information to mobile device 520. The domain service providing apparatus 510 extracts the task information related to the home based on home information from among user profile information included in the user metadata and sends the extracted task information to the mobile device 520. The task information extracted in connection with the home may be information related to filtering and receiving only phone calls related to the user, and to routing calls related to work as outgoing messages or converting calls related to a work into a voice recording service. In this case, the mobile device 520 may automatically set a task so as to filter and receive only calls related to a user, to guide calls related to work as outgoing messages, or to convert calls related to a work into a voice recording service according to the received task information.

FIG. 6 is a block diagram illustrating a domain service performing apparatus 610 and a domain service providing apparatus 620, according to an embodiment of the present invention.

The domain service performing apparatus 610 includes a domain checking unit 611, a receiving unit 612, a storage unit 613, a transmitting unit 614, and a controller 615. The domain service providing apparatus 620 includes a domain checking unit 621, a transmitting unit 622, a receiving unit 623, and a controller 624. The domain service providing apparatus 620 may be an apparatus for providing a service related to a domain, that is, a domain management apparatus or a domain management server. Additionally, the domain service providing apparatus 620 may be connected to an external Virtual Private Network (VPN) server and a financial institution server.

Referring to FIG. 6, the domain checking unit 611 of the domain service performing apparatus 610 checks that the domain service performing apparatus 610 enters a domain. That is, the domain service performing apparatus 600 checks that a domain change event is generated. In the current embodiment, the domain may be a position-based domain, and may be a real area where the domain service providing apparatus 620 may provide a service. The domain may also be a service area unit where a server or a BS is in charge. That is, it may be an area managed by the domain service providing apparatus 620 in a predetermined network. For example, the domain may be an area covered by a femtocell. However, the present invention is not limited to the above-described example regarding a network, and any network covering a predetermined area may be used.

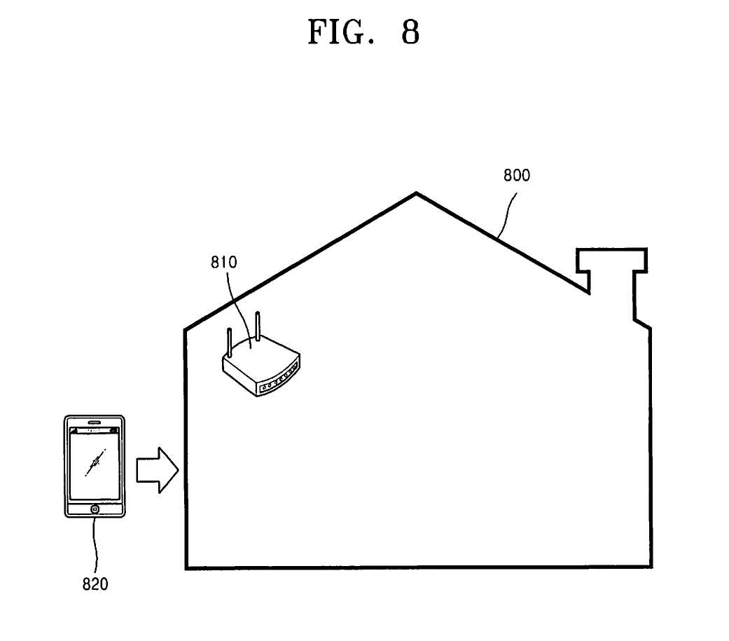

FIG. 8 illustrates a range of a domain 800, according to an embodiment of the present invention.

FIG. 8 illustrates a cover area related to a real area of a domain service providing apparatus 810, that is, a domain 800. In FIG. 8, the domain 800 covered by a domain service providing apparatus 810 is the inside of a building. When a domain service performing apparatus 820, for example, a mobile device, enters a domain of the domain service providing apparatus 810, service information or a service is provided to the mobile device through a predetermined procedure.

One of the methods of checking that the domain service performing apparatus 610 has entered a domain is as follows.

The domain checking unit 611 of the domain service performing apparatus 610 may check the existence of the domain service providing apparatus 620 by receiving a broadcast message that is periodically transmitted from the domain service providing apparatus 620. The domain service performing apparatus 610 then sends a message indicating that the domain service performing apparatus 610 has entered the domain to the domain service providing apparatus 620. In this case, the domain service performing apparatus 610 and the domain service providing apparatus 620 may check whether the other exists.

After the domain service performing apparatus 610 receives the broadcast message of the domain service providing apparatus 620, the domain service performing apparatus 610 may not send a message to the domain service providing apparatus 620.

In this case, even though the domain service performing apparatus 610 does not receive a request for user metadata from the domain service providing apparatus 620, the domain service performing apparatus 610 may send the user metadata to the domain service providing apparatus 620.

Receiving unit 612 of the domain service performing apparatus 610 receives a request for user metadata from the domain service providing apparatus 620.

Storage unit 613 stores user metadata in advance. The user metadata may include user profile information, which is metadata regarding a user's history and user preference information which is metadata regarding content preferred by the user. The user profile information may include, for example, a user's name, sex, age, address, hobby, and an address of a company where the user works. The user preference information may include contents preferred by the user, for example, movies, music, shopping items, etc. However, the present invention is not limited to the above contents of the user profile information and the user preference information, and the contents are not limited. The user may himself set the contents. In the current embodiment, user metadata may be stored in storage unit 613 of the domain service performing apparatus 610, which is a personal apparatus, and managed to prevent any individual privacy problems from occurring.

The transmitting unit 614 of the domain service performing apparatus 610 sends user metadata to the domain service providing apparatus 620. When the user metadata is requested from the domain service providing apparatus 620, the transmitting unit 614 of the domain service performing apparatus 610 sends the user metadata to the domain service providing apparatus 620 in response to the request for the user metadata.

Additionally, the receiving unit 612 of the domain service performing apparatus 610 receives service information related to a domain extracted based on user metadata. A domain service refers to all services related to a domain that may be provided from the domain service providing apparatus 620 to the domain service performing apparatus 610 within a domain area. In the current embodiment, the service information may be information that may be provided to the domain performing apparatus 610 by using the user metadata, that is, user profile information or user preference information. The service information includes task information about a task to be performed in the domain service performing apparatus 610. Accordingly, the receiving unit 612 of the domain service performing apparatus 610 receives the extracted task information based on the user profile information or the user preference information, which is user metadata.

When the domain service performing apparatus 610 receives service information from the domain service providing apparatus 620, the controller 615 of the domain service performing apparatus 610 performs a service according to the service information. If the received service information is task information, the controller 615 of the domain service performing apparatus 610 automatically sets a task according to the task information.

The controller 615 of the domain service performing apparatus 610 does not provide standardized user metadata to the domain service providing apparatus 620 via the transmitting unit 614 of the domain service performing apparatus 610 but may send different user metadata according to a characteristic or type of the domain service providing apparatus 620. For example, the domain service providing apparatus 620 may receive user metadata such as credit card information or an advertisement coupon when the domain service performing apparatus 610 enters a domain such as a store, user metadata related to movie ticket reservation records, movie genres or actors/actresses preferred by the user that may be used in advertisements when the domain service performing apparatus 610 enters a domain such as a theater, user metadata such as ID information related to access or vehicle information that may be used in an automation service such as a driver note when the domain service performing apparatus 610 enters a domain such as an apartment, and user metadata such as a student ID or a task file when the domain service performing apparatus 610 enters a domain such as a school. In this case, the domain service providing apparatus 620 may accurately provide a differentiated service to the domain service performing apparatus 610.

When the domain checking unit 621 of the domain service providing apparatus 620 receives a broadcast message and then receives a response message from the domain service performing apparatus 610, the domain checking unit 621 may check that the domain service performing apparatus 610 has entered a domain. Alternatively, when the domain service performing apparatus 610 sends a predetermined signal to the broadcast message, only the domain service providing apparatus 620 may check the existence of the domain service performing apparatus 610.

The transmitting unit 622 of the domain service providing apparatus 620 may request user metadata from the domain service performing apparatus 610.

The receiving unit 623 of the domain service providing apparatus 620 may receive user metadata from the domain service performing apparatus 610.

The controller 624 of the domain service providing apparatus 620 extracts service information related to a domain based on the received user metadata. The service information may be information regarding all services related to a domain that may be provided from the domain service providing apparatus to the domain service performing apparatus. In the current embodiment, the service information may be information that may be provided to the domain performing apparatus by using user metadata, that is, user profile information or user preference information. The service information includes task information about a task to be performed in the domain service performing apparatus. That is, controller 624 of the domain service providing apparatus 620 may extract task information about a task that may be performed in the domain service performing apparatus according to the user profile information or user preference information, which is a part of the user metadata.

The transmitting unit 622 of the domain service providing apparatus 620 sends the extracted service information to the domain service performing apparatus 610.

When the receiving unit 623 of the domain service providing apparatus 620 receives user metadata including a unique identifier that may identify the domain service performing apparatus from the domain service performing apparatus 610, the controller 624 of the domain service providing apparatus 620 requests authentication of a user based on the user profile information to a VPN server (not shown). When it is determined that authentication information of the domain service performing apparatus received from the domain service providing apparatus has an authentication authority, the VPN server sends a user authentication approval message of the domain service providing apparatus to the domain service providing apparatus. The domain service providing apparatus stores information related to the authentication in a database. When the domain service performing apparatus enters the domain again, this information is automatically used for user authentication. Alternatively, when the domain service performing apparatus 610 directly requests the VPN server to automatically authenticate and then receives the automatic authentication from the VPN server, the domain service performing apparatus 610 may send automatic authentication information to the domain service providing apparatus 620.

If the domain is related to purchasing articles, a user sends a purchase request message regarding the articles to be purchased to the domain service providing apparatus 620 through a predetermined purchasing application, for example, a ringtone or a phone application. The domain service providing apparatus 620 that received the purchase request then sends a purchase approval message to the domain service performing apparatus 610. The purchase approval message includes identification information regarding a subject of the domain service providing apparatus 620. The payment process is as follows. The domain service performing apparatus 610 requests payment approval from a financial institution server (not shown) with respect to the articles the user has requested to purchase, by directly sending the purchase approval message. After the financial institution server approves the payment, the financial institution server directly pays the subject of the domain service providing apparatus 620 based on the purchase approval message. The user may automatically pay for the subject of the domain service providing apparatus without paying through, for example, a credit card.

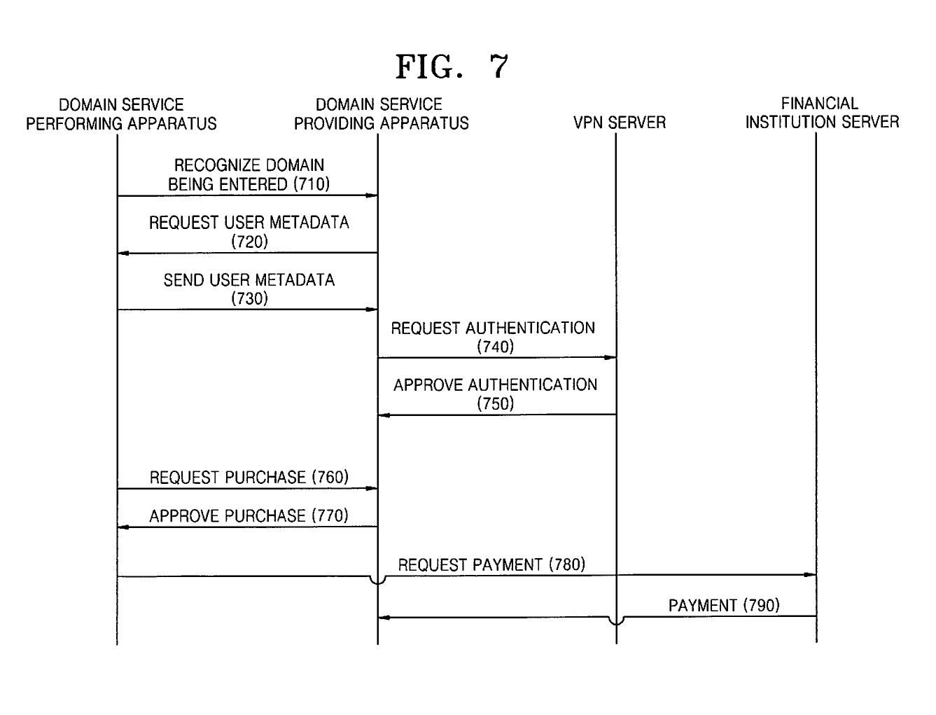

FIG. 7 is a flowchart illustrating a method of performing and providing a domain service, according to another embodiment of the present invention. Referring to FIG. 7, steps 710 through 730 are in regard to a process in which a domain service performing apparatus enters a domain covered by a domain service providing apparatus. steps 710 through 730 are the same as steps 110 through 130, and thus a detailed description thereof will be omitted here. In this regard, user metadata which contains a user profile information including a unique identifier that may identify the domain service performing apparatus.

In step 740, the domain service providing apparatus is a VPN apparatus, and requests user authentication based on user profile information. VPN is a network that uses public networks, such as Internet or a Public Switched Telephone Network (PSTN), an Integrated Service Digital Network (ISDN), or an Asymmetric Digital Subscriber Line (ADSL) of a network service provider, as a Wide Area Network (WAN) backbone of a company. According to a conventional method of accessing a VPN, after an Internet Protocol (IP) address is assigned to a terminal from an external network, user authentication is received from a gateway of the VPN, a private IP address is assigned, and then a data packet is sent or received by using a tunneling technology. A mobile VPN, a concept in which a wired VPN is combined with a mobile device, is a service accessed to a separate line by using VPN Tunneling by a mobile communication user. The mobile VPN consists of a plurality of elements, for example, a mobile node which is a generic term for a mobile access terminal such as a mobile phone, a Personal Digital Assistant (PDA), a Home Agent (HA) router for encapsulating a transmission packet and tunneling the transmission packet to an address registered in a mobile node, a Foreign Agent (FA) router for performing a mobility support mechanism, and an (Authentication, Authorization and Accounting (AAA) server for performing authentication with respect to access of a mobile terminal.

In step 750, when it is determined that authentication information of the domain service performing apparatus received from the domain service providing apparatus has an authentication authority, a VPN server sends a user authentication approval message of the domain service providing apparatus to the domain service providing apparatus. The domain service providing apparatus stores information related to authentication in a predetermined database. When the domain service performing apparatus enters a domain again, this information is automatically used for user authentication. Alternatively, when the domain service performing apparatus directly requests the VPN server for automatic authentication and then receives the automatic authentication from the VPN server, the domain service performing apparatus may send automatic authentication information to the domain service providing apparatus.

In step 760, if the domain is related to purchasing articles, a user sends a purchase request message with respect to the articles to be purchased to the domain service providing apparatus via a predetermined purchasing application, for example, a ringtone or a phone application.

In step 770, the domain service providing apparatus received the purchasing request sends a purchase approval message to the domain service performing apparatus. The purchase approval message includes identification information regarding a subject of the domain service providing apparatus.

In step 770, the domain service performing apparatus requests payment approval from a financial institution server with respect to the articles that the user requested to purchase by directly sending the purchasing approval message.

In step 780, after the financial institution server approves the payment, the financial institution server directly pays the subject of the domain service providing apparatus based on the purchasing approval message. In this case, the user may automatically pay for the subject of the domain service providing apparatus without paying through, for example, a credit card.

Alternatively, if the domain service providing apparatus is a mobile device, when it is determined that a call charge is not proper compared to a user's history, the domain service providing apparatus may provide a service related to the call charge. Then, when a user of the mobile device changes the service related to the call charge, the changed service may be automatically applied when charging the call charge.

Alternatively, when the domain service providing apparatus is a mobile device, call charges that are different depending on a domain may be charged.

The invention can also be embodied as computer readable codes on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, floppy disks, optical data storage devices, and the like. The computer readable recording medium can also be distributed over network coupled computer systems so that the computer readable code is stored and executed in a distributed fashion. Also, functional programs, code, and code segments for accomplishing the present invention can be easily construed by programmers of ordinary skill in the art to which the present invention pertains.

While the present invention has been particularly shown and described with reference to certain embodiments thereof, it will be understood by one of ordinary skill in the art that various changes in form and details may be made therein without departing from the spirit and scope of the present invention as defined by the following claims. The embodiments should be considered in the descriptive sense only and not for the purpose of limiting the claims. Therefore, the scope of the invention is defined not by the detailed description of the invention but by the appended claims, and any differences within the scope of the claims will be construed as being included in the present invention.

What is claimed is:

1. A method of performing a domain service comprising:
receiving a request for user metadata from a domain service providing apparatus managing a position-based domain;
sending the user metadata to the domain service providing apparatus in response to the request; and
receiving service information related to the domain from the domain service providing apparatus based on the user metadata.

2. The method of claim 1, wherein the sending of the user metadata comprises sending user metadata according to a characteristic of the domain service providing apparatus.

3. The method of claim 1, wherein the user metadata comprises user profile information regarding a history of the user.

4. The method of claim 1, wherein the user metadata comprises user preference information regarding content preferred by the user.

5. The method of claim 1, wherein the service information is task information about a task to be performed in an apparatus for performing the domain service, and setting the task is based on the received task information.

6. The method of claim 4, wherein the service is an advertisement based on the preference information of the user.

7. A method of providing a domain service comprising:
when an apparatus entering a position-based domain is recognized, requesting the apparatus to provide user metadata;
receiving the requested user metadata from the apparatus;
extracting service information related to the domain based on the user metadata; and
sending the service information to the apparatus entering the domain.

8. The method of claim 7, wherein the user metadata comprises user profile information regarding a history of the user.

9. The method of claim 7, wherein the user metadata comprises user preference information regarding content preferred by the user.

10. The method of claim 7, wherein the service information is task information about a task to be performed in the apparatus entering the domain.

11. The method of claim 9, wherein the service is an advertisement based on the preference information of the user.

12. A domain service performing apparatus comprising:
a receiving unit receiving a request for user metadata from a domain service providing apparatus for managing a position-based domain;
a controller for determining the user metadata to be sent to the domain service providing apparatus in response to the request; and
a transmitting unit for transmitting the determined user metadata,
wherein the receiving unit receives service information related to the domain based on the user metadata from the domain service providing apparatus.

13. The domain service performing apparatus of claim 12, wherein the controller determines user metadata according to a characteristic of the domain service providing apparatus.

14. The domain service performing apparatus of claim 12, wherein the user metadata comprises user profile information regarding a history of the user.

15. The domain service performing apparatus of claim 12, wherein the user metadata comprises preference information of the preference information regarding content preferred by the user.

16. The domain service performing apparatus of claim 12, wherein the service information is task information about a task to be performed in an apparatus for performing the domain service, and the controller sets the task based on the received task information.

17. The domain service performing apparatus of claim 15, wherein the service is an advertisement based on the preference information of the user.

18. A domain service providing apparatus comprising:
when an apparatus entering a position-based domain is recognized, a transmitting unit for requesting the apparatus for user metadata;
a receiving unit for receiving user metadata from the apparatus; and
a controller for extracting service information related to the domain based on the user metadata and sending the service information to the apparatus entering the domain through the transmitting unit.

19. The domain service providing apparatus of claim 18, wherein the user metadata comprises user profile information regarding a history of the user.

20. The domain service providing apparatus of claim 18, wherein the user metadata comprises user preference information regarding content preferred by the user.

21. The domain service providing apparatus of claim 18, wherein the service information is task information about a task to be performed in the apparatus entering the domain.

22. The domain service providing apparatus of claim 20, wherein the service is an advertisement based on the preference information of the user.

23. A computer-readable recording medium having embodied thereon a program for executing a method of performing a domain service comprising:
receiving a request for user metadata from a domain service providing apparatus for managing a position-based domain;
sending the user metadata to the domain service providing apparatus in response to the request; and
receiving service information related to the domain based on the user metadata from the domain service providing apparatus.

24. A computer-readable recording medium having embodied thereon a program for executing a method of providing a domain service comprising:
when an apparatus entering a position-based domain is recognized, requesting the apparatus for user metadata;
receiving the user metadata from the apparatus;
extracting service information related to the domain based on the user metadata; and
sending the service information to the apparatus entering the domain.
